(19) United States
(12) Patent Application Publication
(10) Pub. No.: US 2011/0131222 A1
(43) Pub. Date: Jun. 2, 2011

(54) PRIVACY ARCHITECTURE FOR DISTRIBUTED DATA MINING BASED ON ZERO-KNOWLEDGE COLLECTIONS OF DATABASES

(75) Inventor: Giovanni DiCrescenzo, Madison, NJ (US)

(73) Assignee: TELCORDIA TECHNOLOGIES, INC., Piscataway, NJ (US)

(21) Appl. No.: 12/782,321

(22) Filed: May 18, 2010

Related U.S. Application Data
(60) Provisional application No. 61/179,183, filed on May 18, 2009.

(51) Int. Cl. G06F 17/30

(52) U.S. Cl. 707/757; 707/E17.005; 707/E17.032

(57) ABSTRACT

A system and method for privacy-preserving distributed data mining are presented. The system comprises clients, servers, and a distributed database comprising databases each residing on a server, wherein original data in each database is changed into masked data using a masking function based on a query template generated by one or more clients, and in response to a query obtained from a client as an instantiation of the query template, the masked data is retrieved and the query result on the original data is obtained using a reconstruction function. The query result can be displayed on a computer. The query template and the query can be functions or protocols among clients. The retrieved masked data and the reconstruction function can compute an accurate query result on the original data without revealing additional information in the database having some original data that generates said query result.

### CROSS REFERENCE TO RELATED APPLICATIONS

The present invention claims the benefit of U.S. provisional patent application 61/179,183 filed May 18, 2009, the entire contents and disclosure of which are incorporated herein by reference as if fully set forth herein.

### FIELD OF THE INVENTION

The present invention relates generally to distributed databases and data mining, and to privacy-oriented architecture for distributed data mining protocols that satisfy strong requirements of privacy, utility, and performance.

### BACKGROUND OF THE INVENTION

Data mining operations can be performed not only on a single database but also when the data is distributed and/or replicated across multiple databases. This scenario is common to a number of real-life applications, including healthcare research, and secure identification. Those desiring to perform data mining in existing systems must accept trade-offs among data privacy, utility and performance. A typical privacy requirement would be that data that is considered private or sensitive by other users is not revealed to the data miner. A typical utility requirement would obtain useful results for the data miner. A typical performance requirement would be to ensure that the query/answer protocols involved during the data mining process satisfy desirable values on conventional performance metrics.

Each of these requirements conflicts with one or both of the others. For example, attaining privacy is especially challenging in light of efforts made during the design of the query/answer protocols to meet the performance and utility requirements. Accordingly, one current class of data retrieval techniques achieves certain strong notions of privacy by sacrificing utility. In this scenario, changes are masked in the data content, making query answers different from those expected or obtained when no privacy is required.

Similarly, meeting the utility requirement is especially challenging in light of any data masking performed while attempting to meet the privacy requirements. Hence, the class of techniques that provides a level of utility has much weaker privacy properties.

Further, attaining the performance requirement is especially challenging in light of the simultaneous privacy and utility requirements. In other words, utility and privacy are almost contradictory requirements, in that improving one tends to make the other worse. In addition, performance is always getting worse whenever an attempt is made to improve either utility or privacy.

Among the multitude of approaches for privacy-preserving data mining is the family of approaches based on secure multi-party computation. These approaches suffer from performance problems in that they all require expensive cryptographic operations, typically based on homomorphic encryption which requires exponentiations modulo large integers.

There is a need for a technique that achieves strong privacy properties, as well as essentially optimal levels of utility and performance. There is also a need for an approach that overcomes performance problems of secure multi-party computation, while achieving similarly satisfactory privacy properties.

### SUMMARY OF THE INVENTION

The inventive system and method provides strong privacy properties, as well as essentially optimal levels of utility and performance.

The inventive system for privacy-preserving distributed data mining, in one aspect, may include one or more clients, at least one of the one or more clients having a processor, one or more servers, and a distributed database comprising a plurality of databases each residing on one of the one or more servers, wherein original data in each database is changed into masked data using a masking function and a query template generated by one or more clients, and in response to a query from one of the one or more clients instantiating the query template, the masked data is retrieved and the query result on the original data is obtained using a reconstruction function. In one aspect, the query result is displayed on a computer. In one aspect, the query or query template can be a practical function selected from the group consisting of subset sum, subset average, comparison, dot product, union, intersection, logarithm and polynomial evaluation. In one aspect, the query or query template may include a function or be generated at the end of a protocol executed among the clients and the masking function and the reconstruction function can be designed based on zero-knowledge databases in accordance with the query function. In one aspect, the retrieved masked data and the reconstruction function allow to compute an accurate query result on the original data without revealing additional information in the database having some original data that generates said query result. In one aspect, the query or query template can be a data mining tool selected from the group consisting of association rules, decision trees, EM clustering, Bayes classifiers, and support vector machines.

A method for privacy-preserving distributed data mining, in one aspect, may include generating a query template for original data in a plurality of databases in a distributed database, masking the original data into masked data, and responding to a query obtained as an instantiation of the query template to retrieve the masked data and then obtain the query result on the original data, using a reconstruction function. In one aspect, retrieving may include displaying the query result on a computer. In one aspect, querying may be performed using a practical function selected from the group consisting of subset sum, subset average, comparison, dot product, union, intersection, logarithm and polynomial evaluation. In one aspect, masking may be performed using a masking function, and the masking function and the reconstruction function can be designed based on zero-knowledge databases in accordance with a function used to perform querying. In one aspect, the retrieved masked data accurately reflects the original data without revealing additional information in the database having the original data. In one aspect, producing a query template can be performed using a data mining tool selected from the group consisting of association rules, decision trees, EM clustering, Bayes classifiers, and support vector machines.

A program storage device readable by a machine, tangibly embodying a program of instructions executable by the machine to perform methods described herein may also be provided.

### BRIEF DESCRIPTION OF THE DRAWINGS

The invention is further described in the detailed description that follows, by reference to the noted drawings by way of non-limiting illustrative embodiments of the invention, in which like reference numerals represent similar parts throughout the drawings. As should be understood, however, the invention is not limited to the precise arrangements and instrumentalities shown. In the drawings:

FIG. 1 is a schematic diagram of the inventive architecture in accordance with a distributed data mining scenario; and

FIG. 2 shows the phases of the present invention.

### DETAILED DESCRIPTION

The invention comprises privacy-oriented architecture for distributed data mining protocols that satisfy strong requirements of privacy, utility, and performance. The novel design is based on a new methodology, called zero-knowledge collection of databases, which strongly safeguards data privacy in addition to providing the desired data utility, in correspondence of queries issued by the client or data miner. The inventive approach includes a privacy-oriented protocol architecture for client access to servers, client-server communication and client-server query/answer interaction in the scenario of servers managing data distributed across multiple databases, and a methodology, called zero-knowledge collection of databases, to allow multiple servers, each holding one database, to produce, on input of a query by a client, masked and randomized versions of their databases so that zero information, in addition to the query answer, is revealed to the client generating the query.

The inventive approach focuses on building a privacy-preserving data mining architecture that satisfies three main classes of requirements: utility, privacy and performance. Any sound design for such architectures needs to simultaneously satisfy privacy and utility requirements, as trivial approaches would satisfy one without the other. Performance requirements are of special interest as some of the solutions that are most technically appealing for their privacy/utility properties, e.g., solutions coming from the cryptography literature, have especially uninteresting performance properties.

Several utility metrics have been proposed, motivated by a large class of statistical methods sacrificing utility to fulfill privacy demands. In the present invention, the highest possible utility properties are achieved, yet the invention is especially used to increase privacy. The high utility properties are attained by requiring that exact answers are provided to the client when needed, or otherwise approximate answers are provided (if sufficient), where approximation can be defined using suitable distance metrics. For instance, if the answer are vectors of bits, then the distance metric can be defined as the Hamming distance (i.e., the number of bits in which two bit vectors differ); if the answers are tuples of integers or real values in a defined space, the distance metric can be defined as the Euclidean distance in that space.

Building on the simulation paradigm of zero-knowledge proof and cryptography, our novel solution achieves the following strong version of privacy, which has not previously been considered in the privacy-preserving data mining literature. Assuming servers honestly cooperate, when perfect accuracy of query results is needed, a perfectly accurate answer to a query reveals nothing about the database other than the answer itself. When approximate query results are sufficient, which is typically the case for data mining projects of statistical nature, an approximately accurate answer to a query reveals nothing else about the database other than the approximate answer itself, where the approximation is computed so that privacy is maintained against an attacker using multiple queries to distinguish among any two different data sources. The previous two privacy requirements can be extended to hold in the presence of “honest-but-curious” servers, as well as when some servers may have some restricted forms of malicious behavior. The second notion further builds on recent advances on privacy-preserving data mining via output perturbation.

Main performance metrics can be communication, time, round complexity of interaction between servers and server-client interactions. The obvious performance requirements are minimizing these metrics, and, whenever possible, using cryptographic or information-theoretic techniques with high performance.

As mentioned in the privacy requirement, a distinction between authorized clients and unauthorized entities is useful in focusing the design of a privacy-preserving data mining architecture in accordance with the present scenario. An appropriate combination of well-known security and cryptographic techniques can be used to deal with unauthorized entities, and these techniques can be shown to be compatible with our novel techniques that deal with authorized clients. Briefly speaking, known techniques like data encryption, data and entity authentication, and data time-stamping can be used to secure server-to-server and server-to-client communication and prevent an unauthorized entity from using such communication to derive information about the databases' content. Moreover, known access control techniques with appropriate data granularity can be used in the client-to-server interaction to further guarantee that only authorized clients gain access to any given area of a server's database.

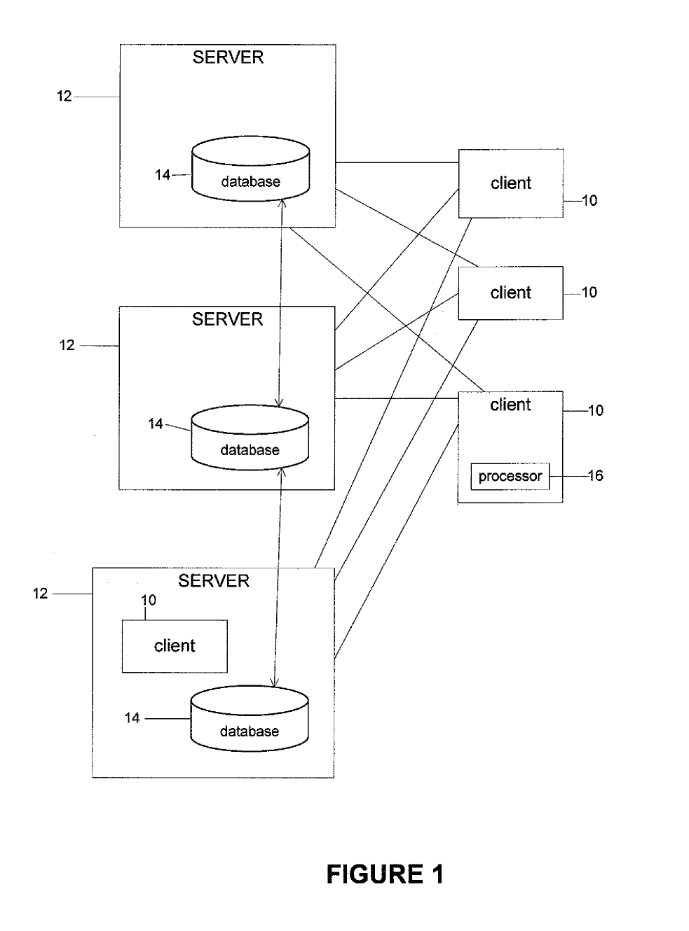

A distributed data mining scenario illustrating the novel approach in accordance with the inventive architecture is shown in FIG. 1. The scenario includes multiple data miners or clients 10, but unless otherwise mentioned, the discussion is simplified to consider a single client, and multiple servers 12, each holding one database 14, where the databases 14 can be horizontally, vertically, or arbitrarily partitioned. One or more of the clients can include a processor 16. In this model, the multiple clients 10 are interested in making arbitrary queries to servers 12, where queries are functions of data distributed across all databases 14. In a main mode of operation, which is not the only mode, this functionality will be supported by the following protocols.

The Querying Notification protocol enables the client to send its query templates to all servers that hold data of interest to this query. The query templates can also be generated by more clients after executing an interactive communication protocol among them. The Masking protocol allows the servers, given the query template sent to them by the client as input, to exchange pseudo-data that is used to generate masked versions of their databases. The Answer Collection protocol provides the client with access to all servers (that hold data of interest to this query), and retrieves the masked versions of their databases. Then the client generates one or more queries as specific instances of the previously issued query template and uses the masked databases to reconstruct an answer or query result to his queries.

The querying and masking protocols can be executed in an off-line phase, for example, at the beginning of the data mining project, when only query templates are known and no specific instances have been generated, and the answer collection protocol can be executed in an on-line phase, such as during the execution of the data mining project, at the client's will, and without need of assistance, other than data access, from the servers.

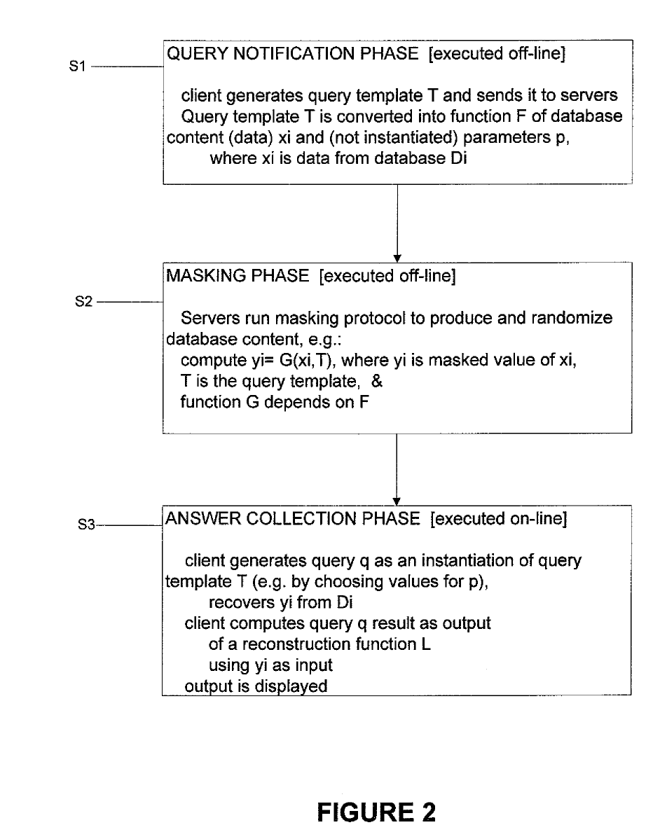

FIG. 2 shows the phases of the present invention as a flow diagram. For simplicity of description, first consider the case of a single client that has a single query template T that can be instantiated into queries q₁, . . . , qₘ, whose answers ans₁, . . . , ansₘ require data from an arbitrary subset of the servers' databases. (Extending the treatment to multiple clients, each having multiple query templates, requires some care but can be done in accordance with the present invention.) Then the basic mode of operation of our privacy-preserving data mining architecture can be divided into three phases: querying notification, database masking and answer collection.

In the query notification phase, step S1, a client or data miner sends query template T to the appropriate subset of servers S₁, . . . , Sₙ. While there is in principle no pre-agreed mathematical language that the client uses to specify queries, assume that T can be translated by the servers into a language common to all servers as a mathematical function T=F of parameters p₁, . . . , pₛ, and of content in their databases D₁, . . . , Dₙ. Here, parameter pᵢ can be instantiated as a value in some pre-specified set, and content xᵢ should be computable only from database Dᵢ with server Sᵢ, for i=1, . . . , n. Moreover, for any value given to parameters p₁, . . . , pₛ, query template can be instantiated into a single query q=T(p₁, . . . , pₛ, x₁, . . . , xₙ), and the answer can be computable as ans=F(x₁, . . . , xₙ). In one aspect, the query template can be a function of not instantiated parameters and original data locations.

In the database masking phase, step S2, a masking protocol is performed. The protocol can be between the servers based on one or more clients' query template. In principle, no pre-agreed data structure or model is shared among databases D₁, . . . , Dₙ, servers; hence, S₁, . . . , Sₙ modify content in their databases into a common data model so that the assumption can be made that database Dᵢ contains element xᵢ, for i=1, . . . , n. At this point S₁, . . . , Sₙ run a masking protocol to process their database content and sufficiently randomize it by jointly computing a function (y₁, . . . , yₙ)=G(x₁, . . . , xₙ; T), where function G depends on query template T and function F, and one can assume that database Dᵢ contains element yᵢ (considered as the masked version of xᵢ guaranteeing data privacy), for i=1, . . . , n.

Finally, in the answer collection phase, step S3, which is typically executed on-line, the client connects to databases recovers element yᵢ from database Dᵢ, for i=1, . . . , n, and generates queries qᵢ, . . . , qₘ as instances of query template T (i.e., each query qᵢ is obtained by setting a specific value for parameters p₁, . . . , pₛ in T). Then the client computes the output ansᵢ′=L(qᵢ, y₁, . . . , yₙ) of a reconstruction function L. Here, function L should depend on functions F, G in a way that

ansᵢ′=L(qᵢ,y₁, . . . ,yₙ)=L(G(x₁, . . . ,xₙ;T))≈F(x₁, . . . ,xₙ)=ansᵢ,

where the ≈ can be equality or similarity according to a specific metric, depending on utility requirements. The output, such as a query result, can be displayed on a computer.

In extended modes of operation, these protocols are extended to take into account dynamic updates to queries and databases, re-distribution of the protocols across different time orderings and different assignment to off-line and on-line phases, and/or introduction of an additional trusted server that performs the masking function on behalf of all data servers.

As described, the data querying and database masking phases can be considered off-line phases, in that they can be executed at the beginning of a health-care research or other project, and the answer collection phase can be considered an on-line phase, as it is expected to be executed by the client at a time of his own choice, for instance, during the execution of the data mining project. The results of the answer collection phase can be displayed on a computer, such as a computer monitor, mobile device, etc.

Crucial to the design of the above mode of operation is the design of a Masking protocol for a function G and a reconstruction function L for any given query function F of interest. Practical functions F can be considered, such as subset sum and average (of which a brief solution approach is sketched below), comparison, dot product, union, intersection, logarithm and polynomial evaluation, which are known to have applications to the following data mining tools: association rules, decision trees, EM clustering, Bayes classifiers, support vector machines.

The design of suitable G,L for any such F, will, in turn, be based on the privacy tool called zero-knowledge databases. Thanks to this tool, the data privacy against the client is guaranteed by the fact that the masked values y₁, . . . , yₙ reveal no additional information to the client other than the value of L(G(x₁, . . . , xₙ; T)), assuming that servers behave honestly. Similarly, depending on function F, the data privacy against servers is guaranteed by the fact that function G in the Masking protocol is designed to reveal nothing about other servers' inputs.

Attractive performance properties are guaranteed by the simplicity of the techniques used to design L,G, which minimize the use of expensive cryptographic computations, as exemplified below with the subset average function. Finally, utility is also maximized as already discussed at the end of the answer collection phase.

The above approach first aims at guaranteeing utility and then, given that utility is satisfied, aims at essentially the best possible privacy, in that it reveals no information other than the query result.

Zero-knowledge collection of databases can be used as a crucial methodology to design a Masking protocol for a function G and a reconstruction function L for any given query function F of interest. An important idea behind zero-knowledge collection of databases is to handle multi-database query/answer interactions, “without revealing anything” to the client about the database inputs x₁, . . . , xₙ other than the (approximate or exact, if needed) answer.

Another concept is that of “minimizing the information revealed” to the servers about other servers' inputs or any database contents. The phrases between quotes are formally expressed using formalizations from the zero-knowledge proof literature, which has received attention from researchers in cryptography and computer science, and is in turn based on simulation-based formalizations of privacy which are central throughout cryptography.

Specifically, the following privacy notions can be formulated for zero-knowledge collections of databases.

Simulation-based privacy against client: Given ans′, the client can generate a tuple (sim-y₁, . . . , sim-yₙ) that is statistically indistinguishable from the tuple (y₁, . . . , yₙ) received from databases D₁, . . . , Dₙ. Here, the intuition is that the ability for the client to simulate the database contents (y₁, . . . , yₙ) given only the answer ans′, implies that the only information obtained during the protocol is precisely ans′.

Simulation-based privacy against (honest-but-curious) servers: Given the communication tr exchanged during the Masking protocol, the subset of servers T₁, . . . , Tₖ from {S₁, . . . , Sₙ}, for k<n, can, given a short (possibly empty) auxiliary input aux, generate an output tr′ that is statistically indistinguishable from tr. As before, the ability for servers to simulate tr given only a short and possibly empty auxiliary input implies that the information obtained during the protocol about other databases is small or empty.

Consider the case of a query template consisting of a project interested in studying how salaries in a corporation vary according to the level of the employee in the company job hierarchy and according to the number of years an employee has worked for the corporation. Analogously, consider a project interested in studying how the severity of a certain disease affects people of a certain age and of a certain region of the country. Both example scenarios could generate a query template that computes the average of certain values (salary values or disease severity values, respectively) among all database entries that satisfies certain parameter values (on hierarchy level and number of years, or age and country region, respectively). In both cases, instantiations of this query template return queries of the average function over certain database values. An example of a zero-knowledge collection of databases for the function F defined as the average of (w log, positive) integers x₁, . . . , xₙ is presented for the inventive privacy-preserving data mining protocols.

Masking protocol: Initially, each server Sᵢ computes zᵢ=xᵢ/n and represents zᵢ in a group Zₚ where p is a prime >2^{a}, a is only slightly larger than the number of significant digits required from integer zᵢ and from the average value, and the representation is computed in a way to preserve ordering (i.e., the integer with digits 12.34 is mapped to the 1234-th element of the group Zₚ). Note that as a result of this representation, the value Σxᵢ/n belongs to the group Zₚ. Now one server, denoted as S₁, leads the masking process among S₁, . . . , Sₙ by computing three random integers r, r₀, r₁ in Zₚ calculated so that their sum modulo p is 0. S₁ sets u₁=z₁+r mod p and replaces x₁ with y₁=n×u₁ mod 2^{a} in D₁. Then S₁ partitions {S₂, . . . , Sₙ} in 2 approximately equal subsets T₀ and T₁ and sends rᵢ to one server in Tᵢ, for i=0,1. From now on, the protocol continues recursively on the two subsets T₀ and T₁; that is, for i=0,1, one server in Tᵢ computes three random integers in Zₚ by summing modulo p to rᵢ, and so on.

Answer Collection protocol: At the end of the Masking protocol, each xᵢ in Dᵢ has been replaced with yᵢ, for i=1, . . . , n, and the client can just retrieve y₁, . . . , yₙ from D₁, . . . , Dₙ and compute Σyᵢ/n mod p=Σxᵢ/n.

Protocol properties can be described as follows. Utility is satisfied by this protocol in a perfect sense, as the client recovers the exact needed value. Furthermore, it can be proved that y₁, . . . , yₙ are random elements of Zₚ such that Σyᵢ/n mod p=Σxᵢ/n, and thus can be efficiently generated by a simulator knowing this value. This implies the privacy against client data or information. Similarly, each rᵢ is a random element of Zₚ, thus implying that each server's view during the Masking protocol is easy to simulate; it can be proved that up to n−1 servers do not obtain any information about the remaining server's database, thus implying a very strong form of privacy against servers. The most interesting property of this protocol is its computation efficiency, as the protocol is very efficient and, in particular, does not use any homomorphic encryption as known protocols in the literature do.

As will be appreciated by one skilled in the art, the present invention may be embodied as a system, method or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.”

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements, if any, in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Various aspects of the present disclosure may be embodied as a program, software, or computer instructions embodied in a computer or machine usable or readable medium, which causes the computer or machine to perform the steps of the method when executed on the computer, processor, and/or machine. A program storage device readable by a machine, tangibly embodying a program of instructions executable by the machine to perform various functionalities and methods described in the present disclosure is also provided.

The system and method of the present disclosure may be implemented and run on a general-purpose computer or special-purpose computer system. The computer system may be any type of known or will be known systems and may typically include a processor, memory device, a storage device, input/output devices, internal buses, and/or a communications interface for communicating with other computer systems in conjunction with communication hardware and software, etc.

The embodiments described above are illustrative examples and it should not be construed that the present invention is limited to these particular embodiments. Thus, various changes and modifications may be effected by one skilled in the art without departing from the spirit or scope of the invention as defined in the appended claims.

What is claimed is:

1. A system for privacy-preserving distributed data mining, comprising:
one or more clients, at least one of the one or more clients having a processor and one or more query templates;
one or more servers; and
a distributed database comprising a plurality of databases each residing on one of the one or more servers, wherein original data in each database is changed into masked data using a masking protocol between the servers based on one of the one or more query templates from one client of the one or more clients; and
in response to a query instantiating the one query template, the masked data is retrieved and a query result on the original data is obtained using a reconstruction function.

2. The system according to claim 1, wherein the query result is displayed on a computer.

3. The system according to claim 1, wherein the one query template is a function of not instantiated parameters and original data locations.

4. The system according to claim 1, wherein the one query template or the query instantiating the one query template is a practical function selected from the group consisting of subset sum, subset average, comparison, dot product, union, intersection, logarithm and polynomial evaluation.

5. The system according to claim 1, wherein the one query template and the query are functions or protocols among multiple clients and the masking protocol and the reconstruction function are designed based on zero-knowledge databases in accordance with the one query template and query functions.

6. The system according to claim 1, wherein the retrieved masked data and the reconstruction function compute an accurate query result based on the original data without revealing additional information in the database having some original data that generates the query result.

7. The system according to claim 1, wherein the one query template or the query is a data mining tool selected from the group consisting of association rules, decision trees, EM clustering, Bayes classifiers, and support vector machines.

8. A method for privacy-preserving distributed data mining, comprising steps of:
generating a query template for original data in a plurality of databases in a distributed database;
masking the original data into masked data using a masking protocol between one or more servers based the query template; and
responding to a query obtained as an instantiation of the query template by retrieving the masked data and obtaining a query result based on the original data using a reconstruction function.

9. The method according to claim 8, the step of responding further comprising displaying the query result on a computer.

10. The method according to claim 8, wherein the step of generating is performed using a practical function selected from the group consisting of subset sum, subset average, comparison, dot product, union, intersection, logarithm and polynomial evaluation.

11. The method according to claim 8, wherein the masking protocol and the reconstruction function are designed based on zero-knowledge databases in accordance with a function used to perform the step of generating.

12. The method according to claim 8, wherein the retrieved masked data and the reconstruction function compute an accurate query result based on the original data without revealing additional information in the database having some original data that generates the query result.

13. The method according to claim 8, wherein the step of generating is performed using a data mining tool selected from the group consisting of association rules, decision trees, EM clustering, Bayes classifiers, and support vector machines.

14. A system for privacy-preserving distributed data mining, comprising:
means for producing a query template for original data in a plurality of databases in a distributed database;
means for masking the original data into masked data based on the query template; and
means for responding to a query obtained as an instantiation of the query template by retrieving the masked data and obtaining the query result on the original data using a reconstruction function.

15. A computer readable storage medium storing a program of instructions executable by a machine to perform a method for privacy-preserving distributed data mining, comprising:
generating a query template for original data in a plurality of databases in a distributed database;
masking the original data into masked data using a masking protocol between one or more servers based on the query template; and
responding to a query obtained as an instantiation of the query template by retrieving the masked data and obtaining a query result based on the original data using a reconstruction function.

16. The computer readable storage medium according to claim 15, wherein responding further comprises displaying the query result on a computer.

17. The computer readable storage medium according to claim 15, wherein generating a query template is performed using a practical function selected from the group consisting of subset sum, subset average, comparison, dot product, union, intersection, logarithm and polynomial evaluation.

18. The computer readable storage medium according to claim 15, wherein the masking protocol and the reconstruction function are designed based on zero-knowledge databases in accordance with a function used to perform the generating.

19. The computer readable storage medium according to claim 15, wherein the retrieved masked data and the reconstruction function compute an accurate query result based on the original data without revealing additional information in the database having some original data that generates the query result.

20. The computer readable storage medium according to claim 15, wherein generating a query template is performed using a data mining tool selected from the group consisting of association rules, decision frees, EM clustering, Bayes classifiers, and support vector machines.
